(19) United States
(12) Patent Application Publication
(10) Pub. No.: US 2003/0009390 A1
(43) Pub. Date: Jan. 9, 2003

(54) Conducting a preliminary world wide web search for attributes of a product through predetermined search queries to predetermined database web sites to provide a purchase profile of the product offered for sale by a web page

(75) Inventors: Gerald Francis McBrearty, Austin, TX (US); Shawn Patrick Mullen, Buda, TX (US); Johnny Meng-Han Shieh, Austin, TX (US)

Correspondence Address: Volel Emile, International Business Machines Corporation, Intellectual Property Law Department, 11400 Burnet Road, Internal Zip 4054, Austin, TX, 78758, US

(73) Assignee: International Business Machines Corporation, Armonk, NY

(21) Appl. No.: 09/899,453

(22) Filed: Jul. 5, 2001

(51) Int. Cl. G06F 17/60; G06F 7/00; G06F 17/30; G06F 17/00

(52) U.S. Cl. 705/26; 707/3; 707/104.1

(57) ABSTRACT

The potential purchaser of a product from a Web page on the Web is provided with a purchase profile of the product which is quicker and easier to obtain and provides more comprehensive data about the products and their sources than any information that a user may obtain about products purchased over the counter from real world stores and like businesses. An implementation is provided for storing at a Web receiving station, a set of predetermined search queries respectively to each of a set of Web database sites for data related to attributes of a selected product and responsive to a selection of a product for sending said search queries to said Web database sites to thereby provide a purchase profile of the product. The sending of the search queries may be set up so as to be automatically responsive to the selection of the product.

The queries are set up so as to trigger very specific or “narrow band” searches to very specific predetermined databases for very specific information. These functions may be carried out in a Web browser at the user's receiving display station or Web station.

### TECHNICAL FIELD

The present invention relates to computer managed communication networks, such as the World Wide Web (Web), and particularly to ease of use of interactive computer controlled display interfaces to such networks for improving user shopping on the Web.

### BACKGROUND OF RELATED ART

The last decade has been marked by a technological revolution driven by the convergence of the data processing industry with the consumer electronics industry. The effect has, in turn, driven technologies that have been known and available but relatively quiescent over the years. A major one of these technologies is the Internet or Web related distribution of documents, media and files. The convergence of the electronic entertainment and consumer industries with data processing exponentially accelerated the demand for wide ranging communication distribution channels, and the Web or Internet, which had quietly existed for over a generation as a loose academic and government data distribution facility, reached “critical mass” and commenced a period of phenomenal expansion. With this expansion, businesses and consumers have direct access to a virtually infinite number of Web documents. In addition, Hypertext Markup Language (HTML), which had been the documentation language of the Internet or Web for years, offered direct links between pages and other documentation on the Web and a variety of related data sources of text and images. This even further exploded the use of the Web. It was now possible for the Web browser or wanderer to literally spend hours going through document after document and accompanying media events in often less than productive excursions through the Web. These excursions often strain the user's time and resources.

In addition, this rapid expansion of the Web has brought in hundreds of millions of Web users, many of whom have relatively little computer skills and sophistication. Consequently, it is critical to the continued expansion of the Web that access to the Web be as simple as possible for the unskilled users and transparent to any problems encountered in operations needed to access requested Web documents. This simplicity in interfacing with the Web must be maintained despite the fact that the rapidly expanding demand for Web facilities and resources has strained the communication capacity and resources of the Web.

A major area of complexity and potential confusion to the less sophisticated user is in trying to make purchases of goods and services through the Web. Selling to consumers over the Web still remains an E-Commerce industry of great potential, but with limited and often awkward execution. The major questions that concern potential purchasers of products on the Web through Web pages are: 1) How reliable is the Web site offering products through this Web page?; 2) How good and reliable is the product which I am considering?; and 3) Am I getting the product at a reasonable price, i.e. a shopping comparison of the product? In order for Web page product purchasing to continue to expand at the current or increased rates, Web page developers are continually striving to make Web product purchasers feel more secure and comfortable with their purchases.

### SUMMARY OF THE PRESENT INVENTION

The present invention provides a system for products sold over the Web which satisfy user concerns about Web site and Web product performance and reliability, as well as product price comparisons to satisfy user cost/value concerns. In its provision of this information, the present invention goes well beyond satisfying the above user reliability concerns. The invention provides the potential purchaser with a purchase profile of the product that is quicker and easier to obtain, and provides more comprehensive data about the products and their sources than any information which a user may obtain about products purchased over the counter from real world stores and like businesses. Thus, the present invention minimizes the negative aspects of shopping on the Web while maximizing the positive advantages of Web shopping relative to over-the-counter shopping.

Accordingly, the present invention provides in a Web communication network with user access through a plurality of data processor controlled user interactive receiving display stations, a system for buying products offered from Web sites comprising means at a receiving display station for displaying a Web page accessed from a Web site; means for selecting a product offered for sale from said Web page; means for storing at said receiving station, a set of predetermined search queries respectively to each of a set of Web database sites for data related to attributes of a selected product; and means responsive to a selection of a product for sending said search queries to said Web database sites to thereby provide a purchase profile of the product. The means for sending the search queries may be set up so as to be automatically responsive to said selection of the product.

The queries are set up to trigger very specific or “narrow band” searches to very specific predetermined databases for very specific information. Such databases may include: a database Web site providing data on the quality of the Web sites offering products; a database Web site providing data on the quality of the selected product; and a database Web site providing data on the comparative price of the selected product at a plurality of Web sites offering the product.

Most of these functions may be carried out in a Web browser at the user's receiving display station or Web station. The browser may include the means for displaying a Web page accessed from a Web site; the means for selecting a product offered for sale from said Web page; the means for storing a set of predetermined search queries respectively to each of a set of Web database sites for data related to attributes of a selected product; and the means responsive to a selection of a product for sending said search queries to said Web database sites.

The means for storing a set of predetermined search queries; and the means responsive to a selection of a product for sending said search queries to said Web database sites may be made available as a plug-in program for any standard browser program.

### BRIEF DESCRIPTION OF THE DRAWINGS

The present invention will be better understood and its numerous objects and advantages will become more apparent to those skilled in the art by reference to the following drawings, in conjunction with the accompanying specification, in which:

FIG. 1 is a block diagram of a data processing system including a central processing unit and network connections via a communications adapter that is capable of functioning as a user interactive Web station for receiving and transmitting Web pages;

FIG. 2 is a generalized diagrammatic view of a Web portion showing how Web sites providing Web pages selling products and services may be accessed to and from the Web stations through browser applications as well as how various databases on the Web may be searched through search queries initiated through these browser applications;

FIG. 3 is a diagrammatic view of a Web page offering to sell products displayed at a receiving display station after a user has selected products and loaded them into his shopping cart;

FIG. 4 is a diagrammatic view of a Purchase Profile Web page presented to a user who has selected products to be purchased in order to aid the user in deciding whether to finalize his purchase of the products;

FIG. 5 is an illustrative flowchart describing the setting up of the process of the present invention for providing a user a purchase profile in order to aid the user in deciding whether to finalize his purchase of selected products; and

FIG. 6 is a flowchart of an illustrative run of the process set up in FIG. 5.

### DETAILED DESCRIPTION OF THE PREFERRED EMBODIMENT

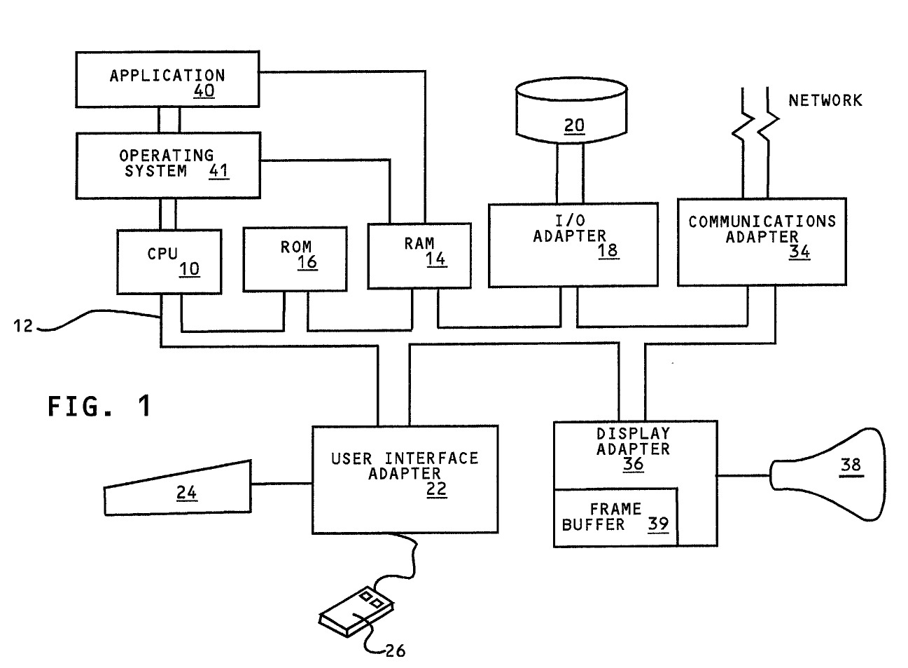

Referring to FIG. 1, a typical data processing terminal is shown which may function as a basic computer controlled network receiving terminal used in implementing the present invention for providing a purchase profile Web page presented to a user who has selected products to be purchased in order to aid the user in deciding whether to finalize his purchase of the products. A central processing unit (CPU) 10, such as one of the PC microprocessors or workstations, e.g. RISC System/6000™ series available from International Business Machines Corporation (IBM), or Dell Corp.'s PC microprocessors, is provided and interconnected to various other components by system bus 12. An operating system 41 runs on CPU 10, provides control and is used to coordinate the function of the various components of FIG. 1. Operating system 41 may be one of the commercially available operating systems such as IBM's AIX 6000™ or Microsoft's Windows98™ or WindowsNT™, as well as UNIX and other IBM AIX operating systems. Application programs 40, controlled by the system, are moved into and out of the main memory Random Access Memory (RAM) 14. These programs include the program of the present invention to be subsequently described in combination with any conventional Web browser, such as the Netscape 3.0™ or Microsoft's Internet Explorer™. A Read Only Memory (ROM) 16 is connected to CPU 10 via bus 12 and includes the Basic Input/Output System (BIOS) that controls the basic computer functions. RAM 14, I/O adapter 18 and communications adapter 34 are also interconnected to system bus 12. I/O adapter 18 may be a Small Computer System Interface (SCSI) adapter that communicates with the disk storage device 20. Communications adapter 34 interconnects bus 12 with an outside network enabling the data processing system to communicate with other such systems over a Local Area Network (LAN) or Wide Area Network (WAN), which includes, of course, the Web or Internet. The latter two terms are meant to be generally interchangeable and are so used in the present description of the distribution network. I/O devices are also connected to system bus 12 via user interface adapter 22 and display adapter 36. Keyboard 24 and mouse 26 are all interconnected to bus 12 through user interface adapter 22. It is through such input devices that the user may interactively relate to the programs for shopping on the Web according to the present invention. Display adapter 36 includes a frame buffer 39, which is a storage device that holds a representation of each pixel on the display screen 38. Images may be stored in frame buffer 39 for display on monitor 38 through various components, such as a digital to analog converter (not shown) and the like. By using the aforementioned I/O devices, a user is capable of inputting information to the system through the keyboard 24 or mouse 26 and receiving output information from the system via display 38.

Before going further into the details of specific embodiments, it will be helpful to understand from a more general perspective the various elements and methods that may be related to the present invention. Since the major aspect of the present invention is directed to Web pages transmitted over global networks, such as the Web or Internet, an understanding of networks and their operating principles would be helpful. We will not go into great detail in describing the networks to which the present invention is applicable. For details on Web nodes, objects and links, reference is made to the text, Mastering the Internet, G. H. Cady et al., published by Sybex Inc., Alameda, Calif., 1996; or the text, Internet: The Complete Reference, Millennium Edition, Margaret Young et al., Osborne/McGraw-Hill, Berkeley, Calif., 1999. Any data communication system that interconnects or links computer controlled systems with various sites defines a communications network. Of course, the Internet or Web is a global network of a heterogeneous mix of computer technologies and operating systems. Higher level objects are linked to the lower level objects in the hierarchy through a variety of network server computers.

Web documents are conventionally implemented in markup languages such as the HTML language, which is described in detail in the text entitled Just Java, Van der Linden, 1997, SunSoft Press, particularly at Chapter 7, pp. 249-268, dealing with the handling of Web pages; and also in the above-referenced Mastering the Internet, particularly pp. 637-642, on HTML in the formation of Web pages.

In addition, aspects of this invention will involve Web browsers. A general and comprehensive description of browsers may be found in the above-mentioned Mastering the Internet text at pp. 291-313. More detailed browser descriptions may be found in the above-mentioned Internet: The Complete Reference, Millennium Edition text, Chapter 19, pp. 419-454, on the Netscape Navigator; Chapter 20, pp. 455-494, on the Microsoft Internet Explorer; and Chapter 21, pp. 495-512, covering Lynx, Opera and other browsers.

Web pages are generally located on the Web and database searches are conducted through search engines. As described in the above-mentioned Internet: The Complete Reference, Milleniun Edition text, pp. 395 and 522-535, search engines use keywords and phrases to query the Web for desired subject matter. The search engine normally uses a search agent called a “spider” that looks for information on Web pages. Such information is indexed and stored in a general database. In carrying out its search, the search engine looks through the general or specific database for matches to keywords subject to the engine syntax. The search engine then presents to the user a list of the Web pages it determines to be closest to the requested query. Some significant search engines are: AltaVista, Infoseek, Lycos, Magellan, Webcrawler and Yahoo. In carrying out the present invention, Web pages selling products may be found through the general database. However, the predetermined search queries to provide the purchase profile are directed as “narrow band” searches to specific predetermined databases.

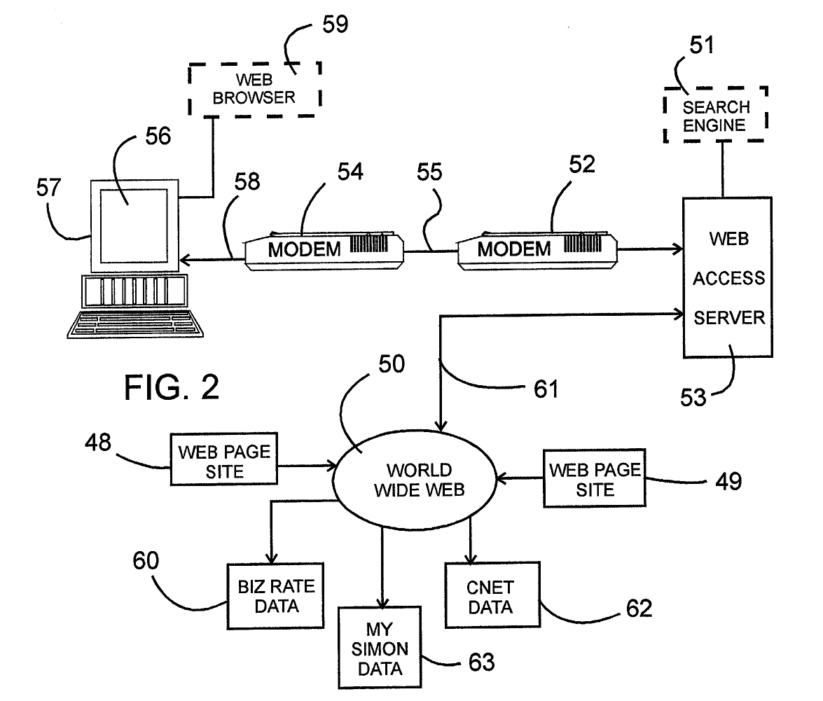

A generalized diagram of a portion of the Web to which the computer controlled display terminal 57 used for Web page receiving during searching or browsing is connected as shown in FIG. 2. Computer display terminal 57 may be implemented by the computer system setup in FIG. 1 and connection 58 (FIG. 2) is the network connection shown in FIG. 1. For purposes of the present embodiment, computer 57 serves as a Web display station and has received displayed Web page 56. Reference may be made to the above-mentioned Mastering the Internet, pp. 136-147, for typical connections between local display stations to the Web via network servers, any of which may be used to implement the system on which this invention is used. The system embodiment of FIG. 2 has a host dial-up connection. Such host dial-up connections have been in use for over 30 years through network access servers 53 that are linked 61 to the Web 50. The servers 53 may be maintained by a service provider to the client's display terminal 57. The server 53 is accessed by the client terminal 57 through a normal dial-up telephone linkage 58 via modem 54, telephone line 55 and modem 52. The HTML file representative of the Web page 56 has been downloaded to display terminal 57 through Web access server 53 via the telephone line linkages from server 53, which may have accessed them from the Internet 50 via linkage 61. The Web browser program 59 operates within the display terminals 57 to control the communication with the Web access server 53 to thereby download and display the accessed Web pages 56 on terminal 57. In carrying out the provision of a pre-purchase profile of the products that the user is selecting in accordance with the present invention, the browser controls the storage in association with display terminal 57 of the set of predetermined search queries to the predetermined databases that the user has selected to provide him with his desired pre-purchase profile. Thus, after the browser has provided Web pages from Web sites like either site 48 or site 49, and as will be hereinafter described in greater detail, when the user is about to check out, i.e. make a purchase, then the browser initiates the stored search queries to the predetermined databases on the Web, such as databases Bizrate 60, CNet 62 and MySimon 63, and provides the Purchase Profile as a Web page 56 at receiving display terminal 57.

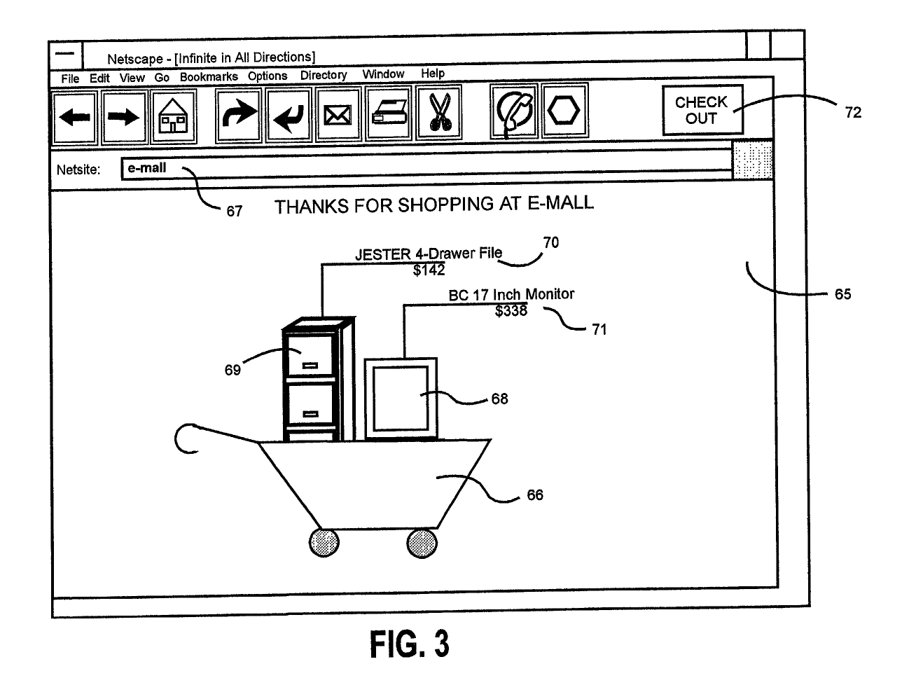

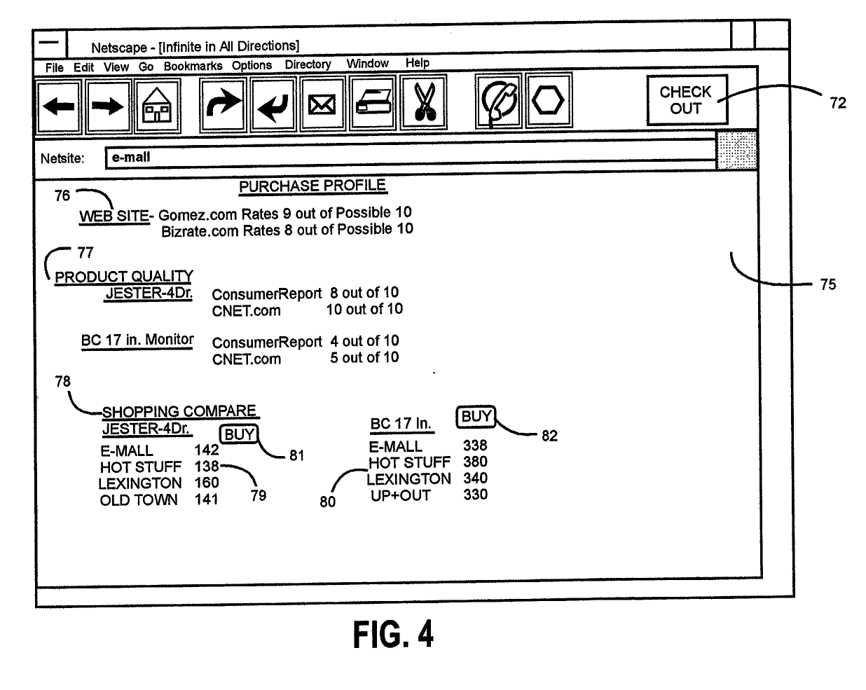

With this setup, the present invention, which will be subsequently described in greater detail with respect to FIGS. 3 and 4, will be carried out using Web browser 59. Search engine 51 accesses Web pages from sites 48 or 49 and provides such pages to the user at terminal 57. FIG. 3 shows a Web page 65 conventionally displayed on screen 56 of terminal 57. The Web access server 53 uses one of the previously described search engines 51 to access via the Web 50 the desired sequence of Web pages from appropriate Web resources, such as sites 48 and 49. The user in this illustration has been shopping in pages from a Web site entitled E-Mall 67 and has selected two items: a Jester 4-Dr File 69 (description 70) and a BC 17 Inch Monitor 68 (description 71), both of which are in his shopping cart. Please note that for clearness in illustration, Web page 65 has been cleared of all extraneous items. The user then presses check out button 72 which initiates the above-mentioned Browser search of databases 60, 62 and 63 through search engine 51 to provide the Purchase Profile Web page 75 shown in FIG. 4. There are ratings 76 of the “E-Mall” Web site itself obtained through two Web site rating databases, “Gomez.com” and “Bizrate.com”, ratings 77 of the two products that are being considered for purchase respectively from ConsumerReport.com and CNet.com, as well as comparison shopping 78 services 79 and 82 for the two products. The user now has an opportunity to review these purchase profiles for the two products. He may then finalize the purchase by pressing the Buy buttons 81 and 82 for each product. If the user selects the Buy button, the browser will then forward all information necessary for billing and shipping to the appropriate Web page site. If the user decides not to buy, then nothing is sent to the Web page site and the purchase transaction is terminated.

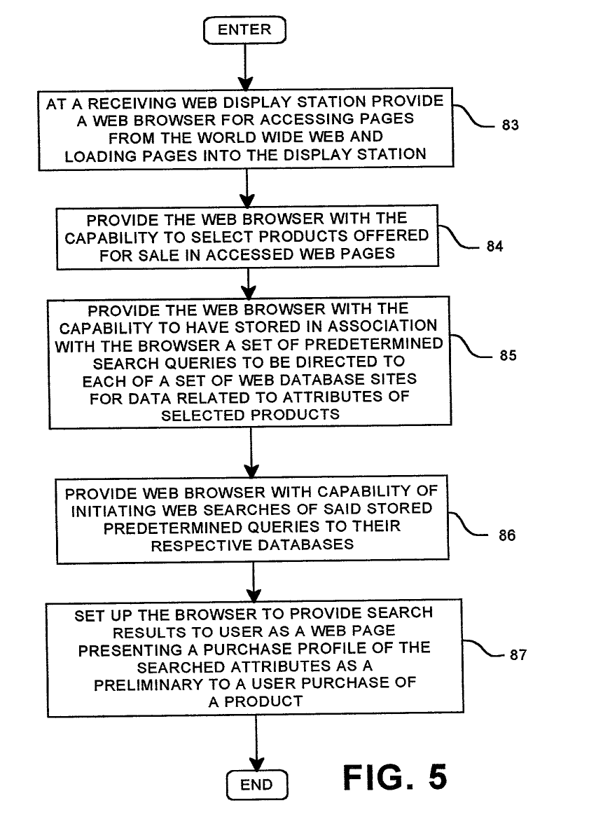

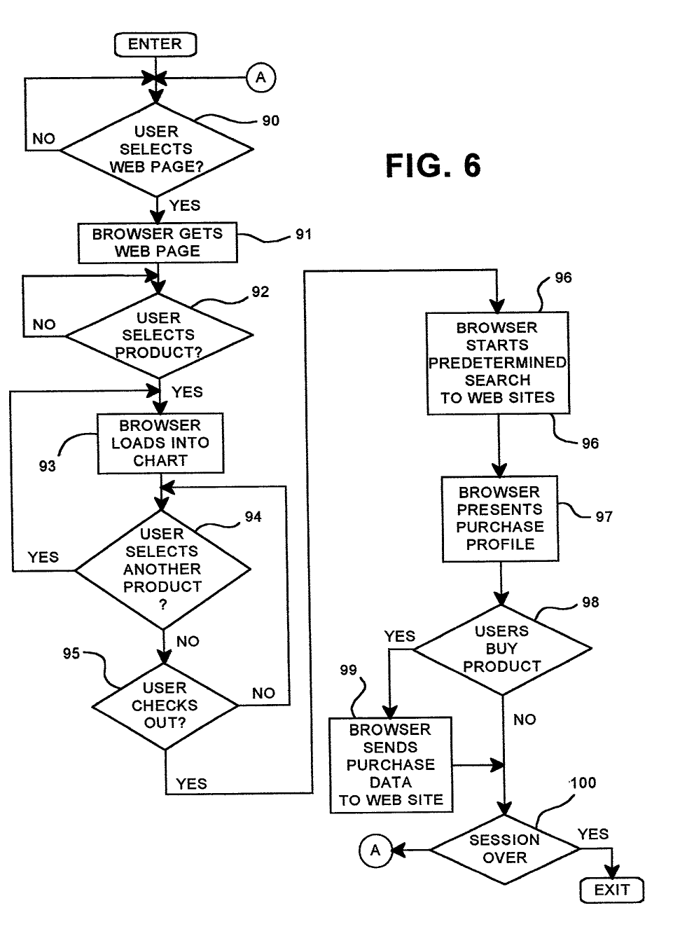

Now, with reference to FIGS. 5 and 6, we will describe a process implemented by the present invention in conjunction with the flowcharts of these figures. FIG. 5 is a flowchart showing the development of a process according to the present invention for presenting a user purchasing products off the Web with a pre-purchase profile of the products. With reference to FIG. 5, first, process step 83, a conventional Web browser program is provided at the Web page receiving display station, e.g. the computer controlled display of FIG. 1 or display station 57 of FIG. 2, for accessing Web pages from the Internet. The browser is set up to provide the capability for the user to select products offered for sale on accessed Web pages, step 84. Now, in order to provide the user with a purchase profile of products being purchased, the browser is provided with the capability to have stored therewith a set of predetermined search queries to each of a set of predetermined Web database sites for data related to attributes of the selected products, step 85. The browser is provided with the further capability of initiating Web searches of said stored predetermined queries to their respective databases, step 86. The browser is set up to provide the results of the above searches to the user as a Web page presenting a Purchase Profile of the searched attributes as a preliminary to a user purchase of a product, step 87.

It should be noted that while the program for creating the purchase profile through the searching with predetermined search queries to predetermined Web databases has been described as an integral part of a Web browser, the program may also be implemented as a plug-in program from any of the standard Web browsers. The plug-in could be set up so as to provide a set of predetermined search queries to a set of predetermined Web database sites. Such plug-ins would provide the user with the option of adding search queries or Web database sites to the default sites or queries provided by the plug-in. The development of Plug-ins for browsers are described in the text, The Web Navigator, Paul Gilster, John Wiley & Sons, New York, 1997 at pages 145-180.

The running of the process will now be described with respect to FIG. 6. First, step 90, a determination is made as to whether the user has selected a Web page. If No, the process is returned to step 90, and the selection of a Web page is awaited. If Yes, the browser gets the Web page, step 91. A determination is then made as to whether the user has selected a product for sale from a Web page, step 92. If No, the process is returned to step 92, and the selection of a product is awaited. If Yes, the browser loads the selected product into the conventional user's cart, step 93, after which a further determination is made as to whether the user has selected another product, step 94. If Yes, the process is returned to step 93 where the browser loads the next selected product into the cart and again a determination is made, step 94 as to whether the user has selected another product. If this time the answer from step 94 is No, another product has not been selected, then a further determination is made, step 95 as to whether the user has clicked on the check-out button. If No, the process is returned to step 94 and the selection of another product is awaited. However if in step 95, the user decides to check out, then the browser commences the predetermined searches to the predetermined database Web sites that have been stored in connection with the browser, step 96. Then, step 97, the browser presents the search results to the user in the form of a purchase profile. With the profile available, the user is then given the opportunity to complete the purchase transaction so as to buy one or more of the products, step 98. If Yes, then the browser sends all of the appropriate billing and shipping data to the Web site of the page, step 99, and the purchase transaction is complete. At this point or if the decision from step 98 is No, then a determination may conveniently be made as to whether the session is over, step 100. If Yes, the session is exited. If No, the process is returned to initial step 90 via branch “A”, and the selection of another Web page is awaited.

One of the preferred implementations of the present invention is as a routine in an operating system made up of programming steps or instructions resident in RAM 14, FIG. 1, during computer operations. Until required by the computer system, the program instructions may be stored in another readable medium, e.g. in disk drive 20, or in a removable memory, such as an optical disk for use in a CD ROM computer input or in a floppy disk for use in a floppy disk drive computer input. Further, the program instructions may be stored in the memory of another computer prior to use in the system of the present invention and transmitted over a LAN or a WAN, such as the Internet, when required by the user of the present invention. One skilled in the art should appreciate that the processes controlling the present invention are capable of being distributed in the form of computer readable media in a variety of forms.

Although certain preferred embodiments have been shown and described, it will be understood that many changes and modifications may be made therein without departing from the scope and intent of the appended claims.

What is claimed is:

1. In a World Wide Web (Web) communication network with user access through a plurality of data processor controlled user interactive receiving display stations, a system for buying products offered from Web sites comprising:
means at a receiving display station for displaying a Web page accessed from a Web site;
means for selecting a product offered for sale from said Web page;
means for storing at said receiving station, a set of predetermined search queries respectively to each of a set of Web database sites for data related to attributes of a selected product; and
means responsive to a selection of a product for sending said search queries to said Web database sites to thereby provide a purchase profile of the product.

2. The Web system for buying products of claim 1 wherein said means for sending said search queries are automatically responsive to said selection of said product.

3. The Web system for buying products of claim 1 wherein one of said search queries is sent to a database Web site providing data on the quality of the Web sites offering products.

4. The Web system for buying products of claim 1 wherein one of said search queries is sent to a database Web site providing data on the quality of the selected product.

5. The Web system for buying products of claim 1 wherein one of said search queries is sent to a database Web site providing data on the comparative price of the selected product at a plurality of Web sites offering the product.

6. The Web system for buying products of claim 1 further comprising:
Web browsing means at said receiving display station including:
said means for displaying a Web page accessed from a Web site;
said means for selecting a product offered for sale from said Web page;
said means for storing a set of predetermined search queries respectively to each of a set of Web database sites for data related to attributes of a selected product; and
said means responsive to a selection of a product for sending said search queries to said Web database sites.

7. In a Web communication network with user access through a plurality of data processor controlled user interactive receiving display stations, a method for buying products offered from a plurality of Web sites comprising:
displaying a Web page accessed from a Web site at a receiving display station;
selecting a product offered for sale from said Web page;
storing at said receiving station, a set of predetermined search queries respectively to each of a set of Web database sites for data related to attributes of a selected product; and
sending said search queries to said Web database sites responsive to a selection of a product to thereby form a purchase profile of the product.

8. The method for buying products of claim 7 wherein said step of sending said search queries is automatically responsive to said selection of said product.

9. The method for buying products of claim 7 wherein one of said search queries is sent to a database Web site providing data on the quality of the Web sites offering products.

10. The method for buying products of claim 7 wherein one of said search queries is sent to a database Web site providing data on the quality of the selected product.

11. The method for buying products of claim 7 wherein one of said search queries is sent to a database Web site providing data on the comparative price of the selected product at a plurality of Web sites offering the product.

12. The method for buying products of claim 7 further comprising:
a Web browsing process at said receiving display station including:
said step of displaying a Web page accessed from a Web site;
said step of selecting a product offered for sale from said Web page;
said step of storing a set of predetermined search queries respectively to each of a set of Web database sites for data related to attributes of a selected products; and
said step of sending said search queries to said Web database sites responsive to a selection of a product.

13. A computer program having code recorded on a computer readable medium for buying products offered from a plurality of Web sites in a Web communication network with user access via a plurality of data processor controlled interactive receiving display stations, said program comprising:
means at a receiving display station for displaying a Web page accessed from a Web site;
means for selecting a product offered for sale from said Web page;
means for storing at said receiving station, a set of predetermined search queries respectively to each of a set of Web database sites for data related to attributes of a selected product; and
means responsive to a selection of a product for sending said search queries to said Web database sites to thereby form purchase profile of the product.

14. The computer program of claim 13 wherein said means for sending said search queries are automatically responsive to said selection of said product.

15. The computer program of claim 13 wherein one of said search queries is sent to a database Web site providing data on the quality of the Web sites offering products.

16. The computer program of claim 13 wherein one of said search queries is sent to a database Web site providing data on the quality of the selected product.

17. The computer program of claim 13 wherein one of said search queries is sent to a database Web site providing data on the comparative price of the selected product at a plurality of Web sites offering the product.

18. The computer program of claim 13 further comprising:
a Web browser program at said receiving display station including:
said means for displaying a Web page accessed from a Web site;
said means for selecting a product offered for sale from said Web page;
said means for storing a set of predetermined search queries respectively to each of a set of Web database sites for data related to attributes of a selected product; and
said means responsive to a selection of a product for sending said search queries to said Web database sites.

19. The computer program of claim 18 wherein said Web browser program further includes a plug-in program including:
said means for storing a set of predetermined search queries respectively to each of a set of Web database sites for data related to attributes of a selected product; and
said means responsive to a selection of a product for sending said search queries to said Web database sites.

20. The computer program of claim 19 further including:
means for adding or deleting predetermined search queries to said set of queries; and
means for adding or deleting Web database sites to said set of Web database sites.
